(19) United States
(12) Patent Application Publication
(10) Pub. No.: US 2014/0297857 A1
(43) Pub. Date: Oct. 2, 2014

(54) TRAFFIC MANAGEMENT DEVICE, SYSTEM, METHOD, AND NON-TRANSITORY COMPUTER READABLE MEDIUM STORING PROGRAM

(71) Applicant: Kousuke Nogami, Minato-ku (JP)

(72) Inventor: Kousuke Nogami, Minato-ku (JP)

(73) Assignee: NEC CORPORATION, Minato-ku, Tokyo (JP)

(21) Appl. No.: 14/354,845

(22) PCT Filed: Oct. 9, 2012
(86) PCT No.: PCT/JP2012/006467

§ 371 Date: Apr. 28, 2014

(30) Foreign Application Priority Data
Dec. 2, 2011 (JP) 2011-264711

(51) Int. Cl. H04L 12/26; H04L 12/24

(52) U.S. Cl. CPC H04L 43/10; H04L 41/50
USPC 709/224

(57) ABSTRACT

A traffic management device according to an exemplary embodiment includes an arrival rate computation unit that computes a traffic volume of upload content be uploaded to each service and converts the traffic volume into an arrival rate in a queue, a processing amount computation unit that collects information on an upload traffic volume which can be processed by each service and converts the upload traffic volume into a processing amount in the queue, a queue management unit that computes a queuing time of the upload content to be uploaded on the basis of both conversation results, and a scheduling computation unit that compares the computed queuing time with a predetermined threshold value and, if the queuing time exceeds the threshold value, regulates the traffic volume of allowable inflow upload content such that the queuing time of the upload content becomes less than the threshold value.

### TECHNICAL FIELD

The present invention relates to a traffic management device, a traffic management system, a traffic management method, and a non-transitory computer readable medium storing a traffic management program and, in particular, to a traffic management device, a traffic management system, a traffic management method, and a non-transitory computer readable medium storing a traffic management program that are intended to control upload traffic in a system that uploads data through a network.

### BACKGROUND ART

In recent years, many services have appeared in which through a network, a user can deposits content, such as an image and a moving image, in a content acceptance server on the network, can access it anytime and anywhere, and can share the content with other users.

Although there is a need to accept upload of content from a large indefinite number of users in these services, it is difficult to accurately estimate an upload traffic amount of the content since the number of users that simultaneously upload the content cannot be controlled. Therefore, in order to make it possible to process a large amount of upload traffic, it is necessary to make investment in equipment enough to reserve a system capacity tailored to a peak of the upload traffic, which is not realistic. Consequently, required is a method for suppressing the peak of the upload traffic to a traffic amount that can be accepted by the services.

A similar problem occurs also in download traffic in a number of users simultaneously viewing content. When the download traffic concentrates on a bottleneck link, for example, a wireless network such as WiFi (Wireless Fidelity), obstacles occur in content viewing, such as stop of reproduction of video content and delay in displaying image data, since the wireless network is congested.

With respect to such problem, in Japanese Unexamined Patent Application Publication No. 2002-271400 of Patent Literature 1 “DATA TRANSMISSION METHOD”, proposed is a method in which in order to perform data transfer with a good efficiency that avoids congestion of a wireless network etc., data to be downloaded is temporarily held within the network, and in which data transfer is performed when a network congestion degree is low.

However, although in a case of Patent Literature 1, such a method is described that a threshold value is previously provided for traffic as a determination criterion in transmission of data being stopped, and that the traffic is determined to be congested when the threshold value is exceeded, a problem exists that there is no method for evaluating setting of the threshold value and validity of the threshold value since a specific method for calculating a congestion degree of the network is not defined. In addition, although in Patent Literature 1, a congestion degree of a content server that delivers content is also included as a congestion target in addition to the wireless network, a specific calculation method therefor is not described, and there is also a problem that implementation means for specifically evaluating the congestion degree is ambiguous.

### CITATION LIST

### Patent Literature

Patent Literature 1: Japanese Unexamined Patent Application Publication No. 2002-271400 (Pages 5 to 8)

### SUMMARY OF INVENTION

### Technical Problem

As described above, since implementation means for appropriately controlling upload traffic is not provided in a related art, there has been a problem not to be able to take measures when a large mount of upload content is generated.

### Object of the Present Invention

The present invention has been made in view of such circumstances, and an object thereof is to provide a traffic management device, a traffic management system, a traffic management method, and a non-transitory computer readable medium storing a traffic management program that can appropriately accept upload traffic even in a case where a traffic amount of a large amount of upload content with respect to a service system is generated in the service system that accepts the upload content.

### Solution to Problem

In order to solve the above-mentioned problem, the following characteristic configurations are mainly employed for a traffic management device, a traffic management system, a traffic management method, and a traffic management program pertaining to the present invention.

(1) A traffic management device pertaining to the present invention manages traffic of upload content for every service, the traffic management device is configured to comprise at least: arrival rate calculation unit for collecting information on the traffic of the upload content for every service, calculating a traffic amount of the upload content for every service to be uploaded, and converting it into an arrival rate in a queue; processing amount calculation unit for collecting information on an upload traffic amount that can be processed by each service that accepts the upload content for every service, and converting it into a processing amount in the queue for every service; queue management unit for calculating a waiting time of the upload content for every service to be uploaded based on the converted arrival rate of upload traffic of each service in the queue and the converted processing amount of the upload traffic; and scheduling calculation unit for comparing the calculated waiting time for every service with a threshold value previously set for every service, and controlling a traffic amount of upload content that is made to flow in a corresponding service so that the waiting time of the upload content becomes not more than the threshold value for every corresponding service, if the waiting time exceeds the threshold value.

(2) A traffic management system pertaining to the present invention is configured to comprise: one or more upload terminals that upload content through a network; one or more content acceptance servers having service systems that accept upload content through the network; one or more node terminals included in a node of the network; and a traffic management device that manages and controls traffic of the upload content uploaded from the upload terminal to the service system of the content acceptance server; wherein the traffic management device includes at least the traffic management device according to (1).

(3) A traffic management method pertaining to the present invention manages traffic of upload content for every service, the traffic management method comprises at least: an arrival rate calculation step for collecting information on the traffic of the upload content for every service, calculating a traffic amount of the upload content for every service to be uploaded, and converting it into an arrival rate in a queue; a processing amount calculation step for collecting information on an upload traffic amount that can be processed by each service that accepts the upload content for every service, and converting it into a processing amount in the queue for every service; a queue management step for calculating a waiting time of the upload content for every service to be uploaded based on the converted arrival rate of upload traffic of each service in the queue, and the converted processing amount of the upload traffic; and a scheduling calculation step for comparing the calculated waiting time for every service with a threshold value previously set for every service, and controlling a traffic amount of upload content that is made to flow in a corresponding service so that the waiting time of the upload content becomes not more than the threshold value for every corresponding service, if the waiting time exceeds the threshold value.

(4) A non-transitory computer readable medium pertaining to the present invention stores a traffic management program, wherein the traffic management method pertaining to (3) is carried out as a program executable by a computer.

### Advantageous Effects of Invention

According to the traffic management device, the traffic management system, the traffic management method, and the non-transitory computer readable medium storing the traffic management program, the following effect can be exerted.

In the present invention, even in a case where a traffic amount of a large amount of upload content with respect to a service system is generated in the service system that accepts the upload content, it becomes possible to appropriately accept traffic of the upload content. This is because a waiting time in a queue of upload content to be uploaded is calculated by modeling a processing amount that can be accepted by the service system and a traffic amount of the upload content to be uploaded using the queue, and influx of the upload content can be suppressed to an amount not more than the traffic amount that can be accepted by the service system by controlling the upload content based on the calculated waiting time.

### BRIEF DESCRIPTION OF DRAWINGS

FIG. 1 is a block configuration diagram showing the first embodiment of a block configuration of the traffic management device pertaining to the present invention.

FIG. 2 is the flow chart for illustrating one example of operation of the traffic management device shown in FIG. 1.

FIG. 3 is a block configuration diagram showing the second embodiment of the block configuration of the traffic management device pertaining to the present invention.

FIG. 4 is the flow chart for illustrating one example of operation of the traffic management device shown in FIG. 3.

FIG. 5 is a block configuration diagram showing the third embodiment of the block configuration of the traffic management device pertaining to the present invention.

FIG. 6 is the flow chart for illustrating one example of operation of the traffic management device shown in FIG. 5.

FIG. 7 is a network configuration diagram showing as the Example 1 one example of a network configuration in the traffic management system pertaining to the present invention.

FIG. 8 is a network configuration diagram showing as the Example 2 another example of a network configuration in the traffic management system pertaining to the present invention.

### DESCRIPTION OF EMBODIMENTS

Hereinafter, with reference to accompanying drawings, will be explained preferred embodiments of a traffic management device, a traffic management system, a traffic management method, and a traffic management program pertaining to the present invention. Note, although in the following explanation, explained are the traffic management device, the traffic management system, and the traffic management method pertaining to the present invention, it is needless to say that such traffic management method may be carried out as a traffic management program executable by a computer, or that the traffic management program may be recorded in a recording medium readable by the computer.

### (Feature of the Present Invention)

Prior to explanation of the embodiments of the present invention, a summary of features of the present invention will be explained first. The present invention has a main feature in which a traffic amount of content that can be accepted by a service system of a content acceptance server and a traffic amount of content requested to be uploaded are modeled using a queue to calculate a waiting time in the queue, and in which upload traffic can be appropriately controlled even in a case where a large amount of upload traffic is generated by determining whether to carry out control of the upload traffic based on the calculated waiting time.

More specifically, the present invention is provided with the following mechanisms. A traffic management device pertaining to the present invention is mainly characterized in that the traffic management device is configured to comprise at least: arrival rate calculation unit for collecting information on the traffic of the upload content for every service, calculating a traffic amount of the upload content for every service to be uploaded, and converting it into an arrival rate in a queue; processing amount calculation unit for collecting information on an upload traffic amount that can be processed by each service that accepts the upload content for every service, and converting it into a processing amount in the queue for every service; queue management unit for calculating a waiting time of the upload content for every service to be uploaded based on the converted arrival rate of upload traffic of each service in the queue and the converted processing amount of the upload traffic; and scheduling calculation unit for comparing the calculated waiting time for every service with a threshold value previously set for every service, and controlling a traffic amount of upload content that is made to flow in a corresponding service so that the waiting time of the upload content becomes not more than the threshold value for every corresponding service, if the waiting time exceeds the threshold value.

In addition, the traffic management device is also mainly characterized in that in the scheduling calculation unit after the traffic amount of the upload content that is made to flow in the corresponding service is controlled so that the waiting time of the upload content becomes not more than the threshold value for every corresponding service, the queue management unit is made to sequentially recalculate the waiting time of the upload content that will be uploaded to the service at a predetermined time interval, and if it detects that the recalculated waiting time decreases not more than the threshold value, upload operation of the upload content of the service temporarily stored in a node of a network is restarted.

In addition, the traffic management device is also characterized in that in the arrival rate calculation unit of the traffic management device, information including at least a transmission destination of the upload content, a data size, and a communication band to the transmission destination is aggregated for every service that serves as the transmission destination, and the traffic amount of the upload content is calculated to convert into the arrival rate in the queue.

In addition, the traffic management device is also characterized in that in the processing amount calculation unit of the traffic management device, in the upload traffic amount that can be processed by the service that accepts the upload content being changed, information on the upload traffic amount that can be processed by the service is collected, and the processing amount in the queue is recalculated according to the changed upload traffic amount that can be processed by the service.

In addition, the traffic management device is also characterized in that in the scheduling calculation unit of the traffic management device, the number of times that the waiting time calculated by the queue management unit exceeded the previously set threshold value is measured for every service at a predetermined time interval, and notification of a guide message including information of the measured number of times is regularly performed to a service system that provides a corresponding service.

Furthermore, the traffic management device pertaining to the present invention is configured to further include a content position management unit that manages location information of the upload content temporarily stored in the node in the network by an instruction of the scheduling calculation unit in addition to the above-mentioned each unit, and the traffic management device is also characterized in that in an access request to upload content being issued from a user, the access request is guided to a node in the network in which the corresponding upload content has been stored.

Furthermore, the traffic management device pertaining to the present invention is configured to further comprise common resource information management unit for monitoring a condition of a common resource and calculating a processing amount in a queue of the common resource when exists the common resource shared by a plurality of service systems that provide respective services in addition to the above-mentioned each unit, and the traffic management device is also characterized in that in the queue management unit the processing amount of each service that shares the common resource that is calculated in the processing amount calculation unit and the processing amount in the queue of the common resource calculated in the common resource information management unit are compared with each other, the processing amount having a smaller value is set as a processing amount in a queue of a corresponding service to use for calculation of a waiting time in a queue of upload content of the service in the waiting time management unit.

### First Embodiment

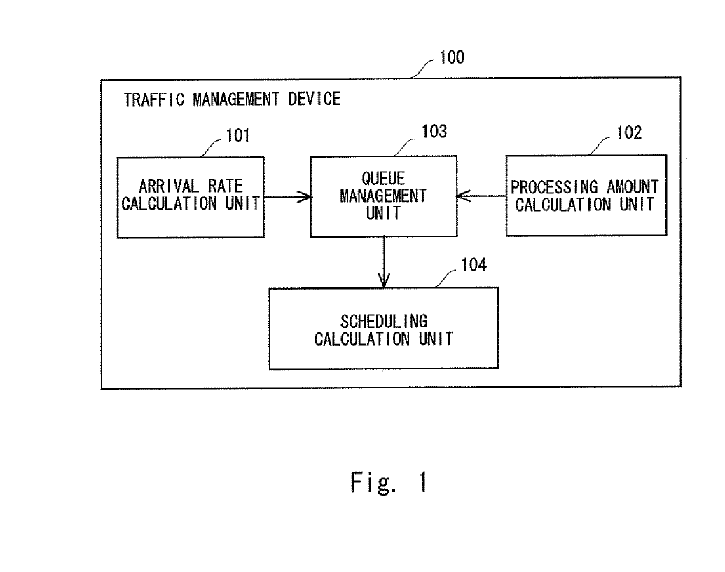

Next, using FIG. 1, will be explained a configuration example of a first embodiment of a traffic management device pertaining to the present invention. FIG. 1 is a block configuration diagram showing the first embodiment of a block configuration of the traffic management device pertaining to the present invention.

The traffic management device 100 shown in FIG. 1 is configured to include at least: an arrival rate calculation unit 101; a processing amount calculation unit 102; a queue management unit 103; and a scheduling calculation unit 104. These respective units operate as follows.

The arrival rate calculation unit 101 collects information on traffic of upload content to a service system for every service, calculates a traffic amount of the upload content for every service to be uploaded, and converts it into an arrival rate in a queue. The processing amount calculation unit 102 collects information on an upload traffic amount that can be processed by each service that accepts the upload content for every service, and converts it into a processing amount in the queue for every service.

The queue management unit 103 calculates a waiting time of the upload content for every service to be uploaded based on the converted arrival rate of the upload traffic and the converted processing amount of the upload traffic in the queue. The scheduling calculation unit 104 compares the calculated waiting time for every service with a threshold value previously set for every service, and if the above-described waiting time exceeds the above-described threshold value, the scheduling calculation unit 104 decides scheduling to control an upload traffic amount that is made to flow in the service so that the waiting time of the upload content becomes not more than the above-described threshold value for every corresponding service.

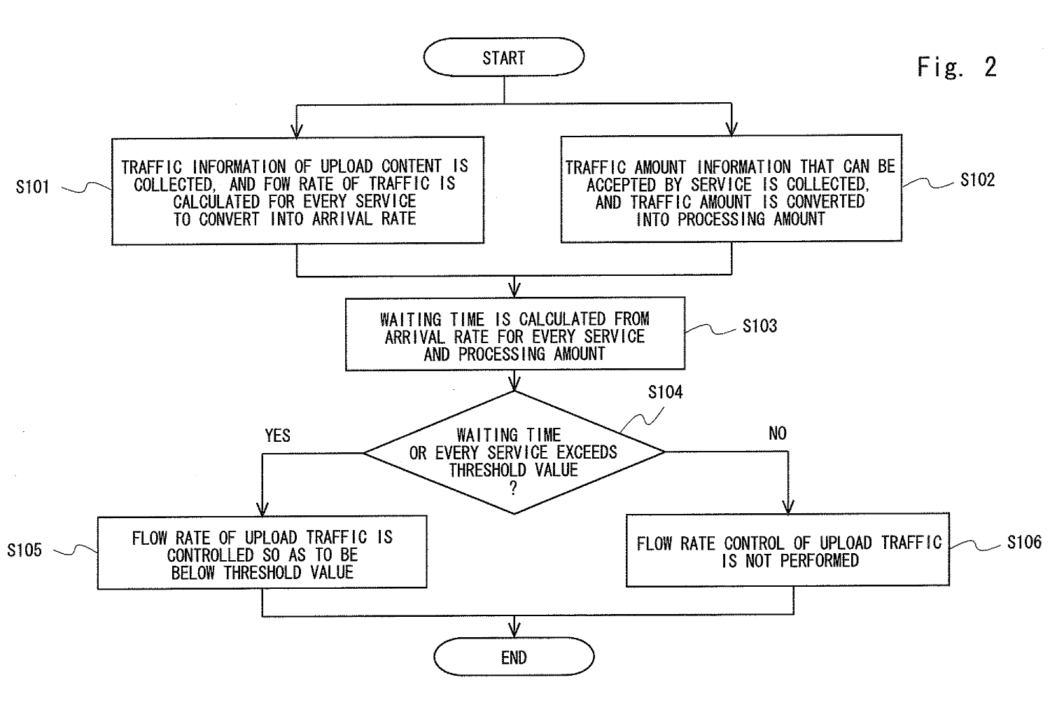

Next, entire operation of the first embodiment will be explained with reference to the traffic management device 100 shown in FIG. 1 and a flow chart shown in FIG. 2. FIG. 2 is the flow chart for illustrating one example of operation of the traffic management device 100 shown in FIG. 1.

In the flow chart of FIG. 2, first, the arrival rate calculation unit 101 collects traffic information of the upload content, calculates a flow rate of the traffic for every service, and converts it into an arrival rate (arrival rate in a queue) regardless of a type and a content of traffic (step S101). In addition, the processing amount calculation unit 102 collects information on a traffic amount that can be accepted by a service system that provides a service for every service, and converts it into a processing amount (processing amount in the queue) regardless of a type of service (step S102).

After that, the queue management unit 103 calculates a waiting time (waiting time of the upload content) using a queuing theory for every service from the arrival rate (arrival rate in the queue) derived for every service in step S101 and the processing amount (processing amount in the queue) derived for every service in step S102 (step S103).

When the waiting time (waiting time of the upload content) is calculated in the queue management unit 103, the scheduling calculation unit 104 compares for every service the waiting time calculated in step S103 with the threshold value previously set for every service (step S104). If the waiting time of the upload content exceeds the previously set threshold value (YES of step S104), the scheduling calculation unit 104 performs scheduling processing to control the flow rate of the upload traffic so that the waiting time does not exceed the set threshold value (step S105).

Meanwhile, if the waiting time of the upload content does not exceed the previously set threshold value (NO of step S104), the scheduling calculation unit 104 determines that the corresponding service is in a state that can accept the upload traffic, and does not perform flow rate control of the upload traffic (step S106).

Such processing from steps S101 to S106 is repeatedly executed regularly or at a timing when changes in conditions occur (for example, when the flow rate of the upload traffic significantly increases or when the traffic amount that can be accepted by the service system changes, etc.).

### (Explanation of Effect of First Embodiment)

Next, an effect of the first embodiment shown in FIGS. 1 and 2 will be explained.

In the first embodiment, in the service system that accepts the upload content, can be obtained the effect in which the service system can process the upload traffic without making much investment in equipment. This is because the traffic amount to be uploaded and the traffic amount that can be accepted by the service system are compared with each other based on a queue model not dependent on a type and a content of traffic and service at all, and if it is difficult for the service system to accept a total amount of the upload traffic, influx of the upload content is controlled until the upload traffic becomes a traffic state that can be accepted by the service system, and thus it becomes unnecessary to make investment in equipment tailored to a peak of flow-in upload traffic in each service system.

### Second Embodiment

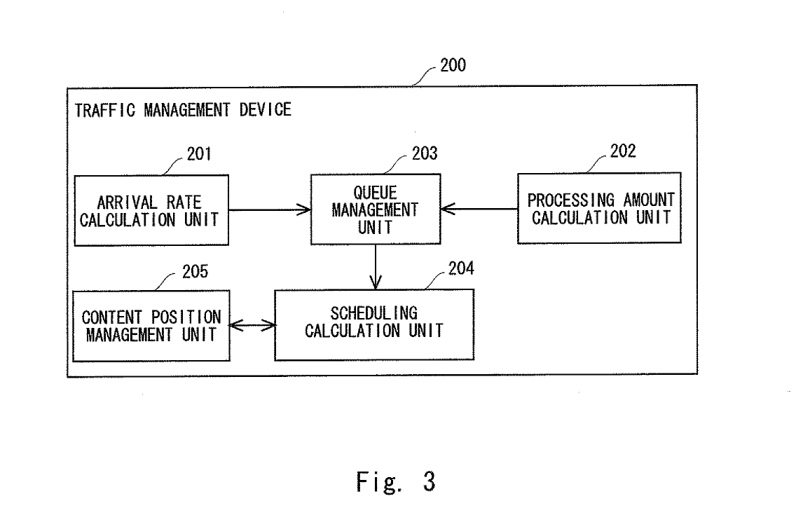

Next, using FIG. 3, will be explained a configuration example of a second embodiment of the traffic management device pertaining to the present invention. FIG. 3 is a block configuration diagram showing the second embodiment of the block configuration of the traffic management device pertaining to the present invention.

A traffic management device 200 shown in FIG. 3 is configured to include at least: an arrival rate calculation unit 201; a processing amount calculation unit 202; a queue management unit 203; a scheduling calculation unit 204; and a content position management unit 205. These respective units operate as follows.

The arrival rate calculation unit 201 is similar to the arrival rate calculation unit 101 of FIG. 1, collects information on traffic of upload content to a service system for every service, calculates a traffic amount of the upload content for every service to be uploaded, and converts it into an arrival rate in a queue. The processing amount calculation unit 202 is similar to the processing amount calculation unit 102 of FIG. 1, collects information on an upload traffic amount that can be processed by each service that accepts the upload content for every service, and converts it into a processing amount in the queue for every service.

The queue management unit 203 is similar to the queue management unit 103 of FIG. 1, and calculates a waiting time of the upload content for every service to be uploaded based on the converted arrival rate of the upload traffic and the converted processing amount of the upload traffic in the queue. The scheduling calculation unit 204 is similar to the scheduling calculation unit 104 of FIG. 1, compares the calculated waiting time for every service with a threshold value previously set for every service, and if the above-described waiting time exceeds the above-described threshold value, the scheduling calculation unit 204 decides scheduling to control an upload traffic amount that is made to flow in the service so that the waiting time of the upload content becomes not more than the above-described threshold value for every corresponding service.

The content position management unit 205 is a unit newly added to the traffic management device 100 of FIG. 1 in the second embodiment, and manages location information of the upload content temporarily stored in a node in a network by an instruction of flow rate control of upload from the scheduling calculation unit 204.

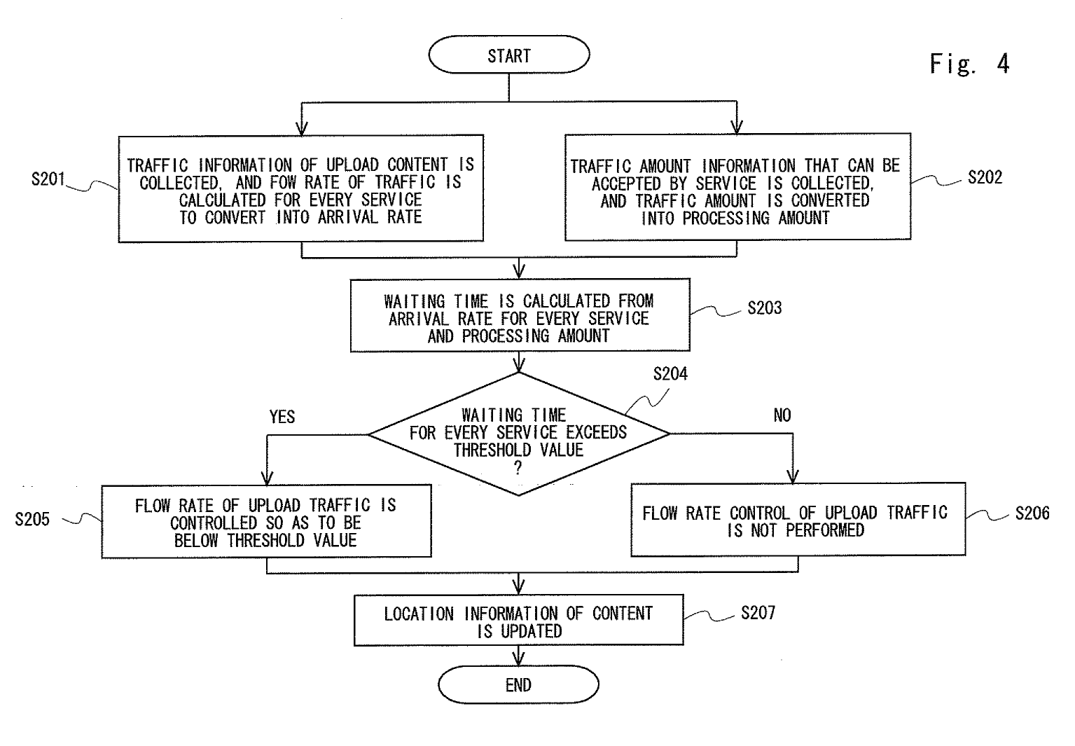

Next, entire operation of the second embodiment will be explained with reference to the traffic management device 200 shown in FIG. 3 and a flow chart shown in FIG. 4. FIG. 4 is the flow chart for illustrating one example of operation of the traffic management device 200 shown in FIG. 3.

In the flow chart of FIG. 4, first, the arrival rate calculation unit 201, similarly to the case of the arrival rate calculation unit 101 shown in FIG. 2, collects traffic information of upload content, calculates a flow rate of the traffic for every service, and converts it into an arrival rate (arrival rate in a queue) regardless of a type and a content of traffic (step S201). In addition, the processing amount calculation unit 202, similarly to the case of the processing amount calculation unit 102 shown in FIG. 2, collects information on a traffic amount that can be accepted by a service system that provides a service for every service, and converts it into a processing amount (processing amount in the queue) regardless of a type of service (step S202).

After that, the queue management unit 203, similarly to the case of the queue management unit 103 shown in FIG. 2, calculates a waiting time (waiting time of the upload content) using the queuing theory for every service from the arrival rate (arrival rate in the queue) derived for every service in step S201 and the processing amount (processing amount in the queue) derived for every service in step S202 (step S203).

When the waiting time (waiting time of the upload content) is calculated in the queue management unit 203, the scheduling calculation unit 204, similarly to the case of the scheduling calculation unit 104 shown in FIG. 2, compares for every service the waiting time calculated in step S203 and the threshold value previously set for every service (step S204). If the waiting time of the upload content exceeds the previously set threshold value (YES of step S204), the scheduling calculation unit 204 performs scheduling processing to control the flow rate of the upload traffic so that the waiting time does not exceed the set threshold value (step S205).

Meanwhile, if the waiting time of the upload content does not exceed the previously set threshold value (NO of step S204), the scheduling calculation unit 204 determines that the corresponding service is in a state that can accept the upload traffic, and does not perform flow rate control of the upload traffic (step S206).

After that, in the second embodiment, furthermore, in the content position management unit 205, location information of the upload content temporarily stored in the node in the network is updated and managed based on an instruction of the scheduling calculation unit 204 (step S207).

Such processing from steps S201 to S207 is repeatedly executed regularly or at a timing when changes in conditions occur (for example, when the flow rate of the upload traffic significantly increases or when the traffic amount that can be accepted by the service system changes, etc.).

### (Explanation of Effect of Second Embodiment)

Next, an effect of the second embodiment shown in FIGS. 3 and 4 will be explained.

In the second embodiment, in addition to the effect of the first embodiment, furthermore, target content can be accessed according to an access request from a user even at a stage where upload processing of the upload content has not been completed. This is because the content as an upload target can be accessed even at a stage where the service system has not received the upload content by performing location management of the upload content temporarily stored in the node in the network as a flow rate control result of the upload content of the scheduling calculation unit 204.

### Third Embodiment

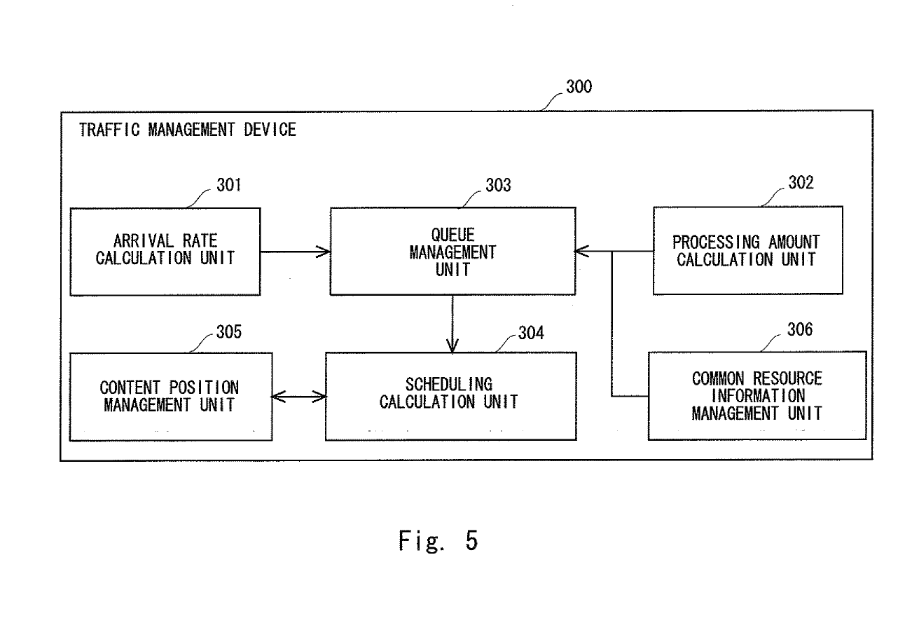

Next, using FIG. 5, will be explained a configuration example of a third embodiment of the traffic management device pertaining to the present invention. FIG. 5 is a block configuration diagram showing the third embodiment of the block configuration of the traffic management device pertaining to the present invention.

A traffic management device 300 shown in FIG. 5 is configured to include at least: an arrival rate calculation unit 301; a processing amount calculation unit 302; a queue management unit 303; a scheduling calculation unit 304; a content position management unit 305; and a common resource information management unit 306.

These respective units operate as follows.

The arrival rate calculation unit 301 is similar to the arrival rate calculation unit 101 of FIG. 1 and the arrival rate calculation unit 201 of FIG. 2, collects information on traffic of upload content to a service system for every service, calculates a traffic amount of the upload content for every service to be uploaded, and converts it into an arrival rate in a queue. The processing amount calculation unit 302 is similar to the processing amount calculation unit 102 of FIG. 1 and the processing amount calculation unit 202 of FIG. 2, collects information on an upload traffic amount that can be processed by each service that accepts the upload content for every service, and converts it into a processing amount in the queue for every service.

The queue management unit 303 is similar to the queue management unit 103 of FIG. 1 and the queue management unit 203 of FIG. 2, and calculates a waiting time of the upload content for every service to be uploaded based on the converted arrival rate of the upload traffic and the converted processing amount of the upload traffic in the queue. However, in the third embodiment, when a service as a target shares a resource with an other service, the queue management unit 303 compares for every service a processing amount in a queue of the common resource with a processing amount in a queue of each service as a target, sets a processing amount having a smaller value as a processing amount of the corresponding service, and calculates a waiting time of the upload content. For example, when the processing amount in the queue of the common resource is smaller than the processing amount in the queue of the service, the queue management unit 303 sets the processing amount in the queue of the common resource as the processing amount (processing amount of the upload traffic) in the queue of the service instead of the processing amount in the queue of the service derived in the processing amount calculation unit 302.

The scheduling calculation unit 304 is similar to the scheduling calculation unit 104 of FIG. 1 and the scheduling calculation unit 204 of FIG. 2, compares the calculated waiting time for every service with a threshold value previously set for every service, and if the above-described waiting time exceeds the above-described threshold value, the scheduling calculation unit 304 decides scheduling to control an upload traffic amount that is made to flow in the service so that the waiting time of the upload content becomes not more than the above-described threshold value for every corresponding service. The content position management unit 305 is similar to the content position management unit 205 of FIG. 2, and manages location information of the upload content temporarily stored in a node in a network by an instruction of flow rate control of upload.

The common resource information management unit 306 is a unit newly added to the traffic management device 200 of FIG. 2, monitors a resource shared by a plurality of service systems, and calculates a processing amount in a queue of the common resource.

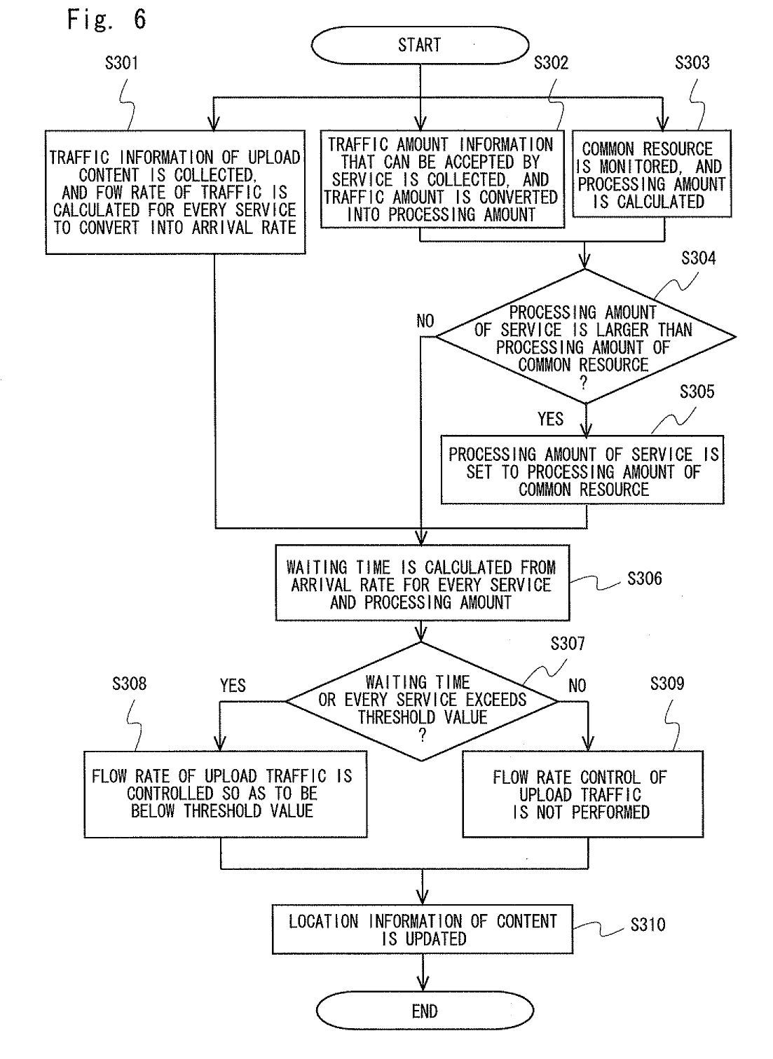

Next, entire operation of the third embodiment will be explained with reference to the traffic management device 300 shown in FIG. 5 and a flow chart shown in FIG. 6. FIG. 6 is the flow chart for illustrating one example of operation of the traffic management device 300 shown in FIG. 5.

In the flow chart shown in FIG. 6, first, the arrival rate calculation unit 301, similarly to the cases of the arrival rate calculation unit 101 shown in FIG. 2 and the arrival rate calculation unit 201 shown in FIG. 4, collects traffic information of upload content, calculates a flow rate of the traffic for every service, and converts it into an arrival rate (arrival rate in a queue) regardless of a type and a content of traffic (step S301). In addition, the processing amount calculation unit 302, similarly to the cases of the processing amount calculation unit 102 shown in FIG. 2 and the processing amount calculation unit 202 shown in FIG. 4, collects information on a traffic amount that can be accepted by a service system that provides a service for every service, and converts it into a processing amount (processing amount in the queue) regardless of a type of service (step S302).

Furthermore, in the third embodiment, the common resource information management unit 306 monitors the resource shared and utilized by a plurality of services, and calculates the processing amount of the resource (step S303).

After that, unlike the cases of the arrival rate calculation unit 101 shown in FIG. 2 and the arrival rate calculation unit 201 shown in FIG. 4, when as for each service, a service is the service that utilizes the common resource, the queue management unit 303 first compares large and small of the processing amount of the target service calculated in step S302 and the processing amount of the common resource calculated in step S303 (step S304).

If the processing amount of the service is not larger than the processing amount of the common resource (NO of step S304), the queue management unit 303 uses the processing amount of the target service calculated in step S302 as it is as a processing amount of a processing target service, but conversely, if the processing amount of the service is larger than the processing amount of the common resource (YES of step S304), the queue management unit 303 sets the processing amount of the processing target service as the processing amount of the common resource calculated in step S303 (step S305). That is, the queue management unit 303 sets the lesser processing amount of the processing amount derived for every service in step S302 and the processing amount of the common resource derived in S303 as a processing amount for every corresponding service of a subsequent processing target.

After that, the queue management unit 203, similarly to the cases of the queue management unit 103 shown in FIG. 2 and the queue management unit 203 shown in FIG. 4, calculates a waiting time (waiting time of the upload content) using the queuing theory for every service from the arrival rate (arrival rate in the queue) derived for every service in step S301 and the processing amount (processing amount in the queue) of the processing target derived for every service in steps S302 to S305 (step S306).

When the waiting time (waiting time of the upload content) is calculated in the queue management unit 303, the scheduling calculation unit 304, similarly to the cases of the scheduling calculation unit 104 shown in FIG. 2 and the scheduling calculation unit 204 shown in FIG. 4, compares for every service the waiting time calculated in step S306 and a threshold value previously set for every service (step S307). If the waiting time of the upload content exceeds the previously set threshold value (YES of step S307), the scheduling calculation unit 304 performs scheduling processing to control the flow rate of the upload traffic so that the waiting time does not exceed the set threshold value (step S308).

Meanwhile, if the waiting time of the upload content does not exceed the previously set threshold value (NO of step S307), the scheduling calculation unit 304 determines that the corresponding service is in a state that can accept the upload traffic, and does not perform flow rate control of the upload traffic (step S309).

After that, furthermore, in the content position management unit 305, similarly to the case of the content position management unit 205 shown in FIG. 4, location information of the upload content temporarily stored in a node in a network is updated and managed based on an instruction of the scheduling calculation unit 304 (step S310).

Such processing from steps S301 to S310 is repeatedly executed regularly or at a timing when changes in conditions occur (for example, when the flow rate of the upload traffic significantly increases or when the traffic amount that can be accepted by the service system changes, etc.).

### (Explanation of Effect of Third Embodiment)

Next, an effect of the third embodiment shown in FIGS. 5 and 6 will be explained.

In the third embodiment, in addition to the effects of the first embodiment and the second embodiment, furthermore, the upload traffic can be appropriately processed also in the service system including the resource shared by the plurality of services as in a network of a data center. This is because the processing amount in the queue of the common resource and the processing amount in the queue of the target service system are compared with each other, and the traffic amount of the upload content is controlled based on the smaller processing amount.

### (Example of Traffic Management System)

Next, in a traffic management system configured to include: one or more upload terminals that upload content through a network; one or more content acceptance servers having service systems that accept upload content through the network; one or more node terminals included in a node of the network; and a traffic management device that manages traffic of the content uploaded from the upload terminal to the service system of the content acceptance server, using specific examples, will be explained operation of a best mode that manages and controls traffic of the upload content by means of a traffic management device. Here, as an Example 1 and an Example 2, will be respectively explained cases where the traffic management device 200 shown in FIG. 3 as the second embodiment and the traffic management device 300 shown in FIG. 5 as the third embodiment are respectively applied as the traffic management device pertaining to the present invention.

### Example 1

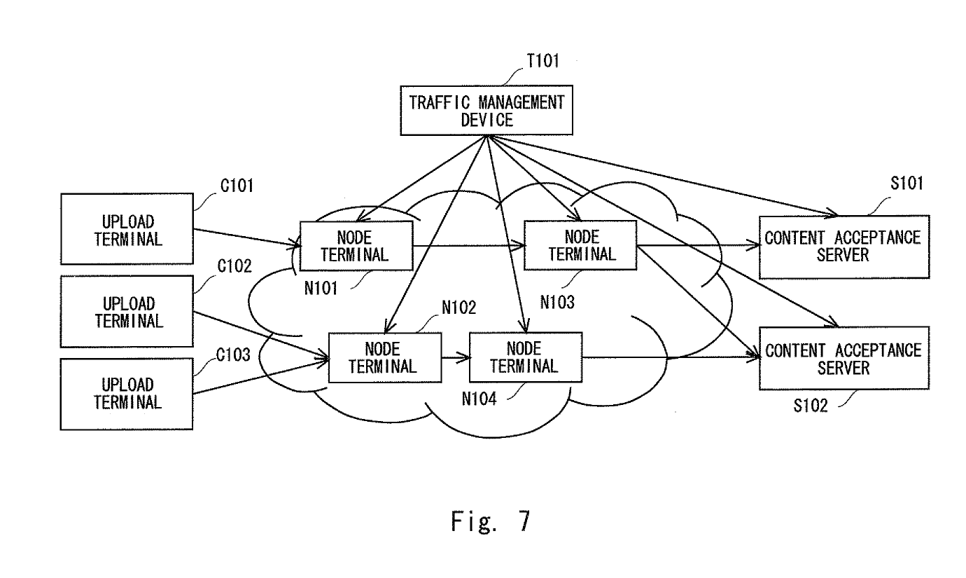

First, specific operation will be explained using FIG. 7 as a specific example of the best mode for carrying out the traffic management system pertaining to the present invention. FIG. 7 is a network configuration diagram showing as the Example 1 one example of a network configuration in the traffic management system pertaining to the present invention, and shows taking as an example a case where the traffic management device 200 shown in FIG. 3 as the second embodiment is applied as the traffic management device included in the traffic management system. It is to be noted that the traffic management device 200 shown in FIG. 3 is shown as a traffic management device T101 in FIG. 7.

The traffic management system shown in FIG. 7 includes: the traffic management device T101 including the traffic management device 200 shown in FIG. 3; three upload terminals C101, C102, and C103 that upload content; two content acceptance servers S101 and S102 having service systems that accept content to be uploaded; and four node terminals N101, N102, N103, and N104 that are included in a node of a network. It is to be noted that the number of terminals and servers shown in FIG. 7 shows one example, and the arbitrary number of them may be used without limiting to the above number.

Here, the four node terminals N101, N102, N103, and N104 that are included in the traffic management system of FIG. 7 temporarily store content that will be uploaded from the upload terminals C101, C102, and C103 to the service systems of the content acceptance servers S101 and S102 based on control information from the traffic management device T101 until a waiting time of upload content of the corresponding service system decreases a value not more than a threshold value set in advance, thereby enabling to control upload traffic to the content acceptance servers S101 and S102.

In the traffic management system of FIG. 7, each of the upload terminals C101, C102, and C103 uploads content to the service systems of the content acceptance servers S101 and S102 for every service. In this case, the upload terminals C101, C102, and C103 do not directly perform upload to each of the service systems of the content acceptance servers S101 and S102, but perform upload processing to any of the node terminals N101, N102, N103, and 104.

Here, selection of the node terminal serving as an upload destination, i.e., the upload destination node terminal, is performed in consideration of elements, such as load states of the node terminals N101, N102, N103, and N104, and vicinity with the upload terminals C101, C102, and C103, and notification of the upload destination node terminal to the upload terminals C101, C102, and C103 is performed through means, such as DNS (Domain Name Server) processing and redirection processing.

The content acceptance servers S101 and S102 respectively measure a traffic amount of content that can be accepted by their service systems, and notify the traffic management device T101 of the information regularly or when the acceptable traffic amount is changed. The traffic amount of the content that can be accepted by the content acceptance servers S101 and S102 decreases, for example, when a failure occurs in the server and the network of the service system, and it increases when failure recovery of the service system and enhancement of the service system are performed.

The node terminals N101 and N102, N103, and N104 that temporarily store the upload content uploaded from the upload terminals C101, C102, and C103 notify the traffic management device T101 of information indicating that the upload content is stored. As information notification of which is performed to the traffic management device T101, included are information on the stored upload content, information on connection states of the corresponding node terminal and the content acceptance servers S101 and S102, etc. In addition, as the information on the upload content, included are information on the content acceptance servers S101 and S102 that serve as the upload destinations, information on a time when the upload content has accepted, information on a size etc. of the upload content. As the information on the connection states of the corresponding node terminal and the content acceptance servers S101 and S102, included is information on presence/absence of reachability, a delay, an available band, etc.

The node terminal N101, N102, N103, and N104 regularly confirm the connection states with the content acceptance servers S101 and S102, and update the information. The traffic management device T101 classifies the information on the upload content collected from the node terminals N101, N102, N103, and N104 for every service system of the content acceptance servers S101 and S102, and calculates an upload traffic amount to the service system of each of the content acceptance servers S101 and S102.

Furthermore, the traffic management device T101 calculates a waiting time in a queue of the service system of each of the content acceptance servers S101 and S102 from an acceptable traffic amount collected from the service system of each of the content acceptance servers S101 and S102, and the upload traffic amount to the service system of each of the content acceptance servers S101 and S102. The traffic management device T101 previously has a threshold value regarding the waiting time of the service system of each of the content acceptance servers S101 and S102. The threshold value is, for example, a numerical value previously decided by a contract of a service provider that provides the service systems of the content acceptance servers S101 and S102 and a business operator who operates the traffic management device T101, and is set to the traffic management device T101 in advance.

The traffic management device T101 compares large and small of the calculated waiting time in a queue and the threshold value set in advance, and if the waiting time exceeds the threshold value, the traffic management device T101 controls the traffic amount of the upload content so that it falls within the threshold value. As a specific method for controlling the amount of upload content traffic, for example, there is a method for suppressing the amount of upload traffic from all the node terminals N101, N102, N103 and N104 so that any content for which the date when the upload content was accepted is newer is not uploaded. Furthermore, when the upload traffic amount is controlled in the scheduling calculation unit 304 shown in FIG. 5, the traffic management device T101 sequentially recalculates a waiting time of subsequent upload content at a predetermined time interval in the queue management unit 303 shown in FIG. 5, and if the waiting time becomes a value not more than the threshold value, the traffic management device T101 instructs a control method of the upload traffic amount to each node terminal, and restarts upload operation of the temporarily stored upload content of the corresponding service.

Each of the node terminals N101, N102, N103, and N104 that have received a control instruction of the upload operation restart from the traffic management device T101 restart processing to upload the upload content to the content acceptance servers S101 and S102 based on a content of the received control instruction. It is to be noted that although the upload content is temporarily stored on the node terminals N101, N102, N103, and N104, the traffic management device T101 manages location information of the upload content that indicates which node terminal the corresponding upload content is stored in, and that if an access request to the content temporarily stored on the node terminals N101, N102, N103, and N104 is issued from the user, the traffic management device T101 guides the access request to the node terminal in which the corresponding content is temporarily stored.

For example, if the user requests access to content that is about to be uploaded to the content acceptance server S101, and if the node terminal that temporarily stores the corresponding content is the node terminal N103, the traffic management device T101 guides the access request from the user to the node terminal N103. For this purpose, the traffic management device T101 provides a DNS function to access the node terminal in which designated content is stored, or provides a function to provide information of the node terminal in which requested content is stored with respect to the content acceptance server that performs redirection processing to the corresponding node terminal.

It is to be noted that although in the above explanation of the Example 1, has been described a case where each of the node terminals N101, N102, N103, and N104 executes processing to directly upload content to the content acceptance servers S101 and S102, the node terminals N101, N102, N103, and N104 can also upload the content to an other node terminal.

For example, assume that the node terminal N102 is instructed to interrupt content upload to the content acceptance server S102. At this time, the node terminal N102 can also upload the content, for example, to the node terminal N104 instead of uploading it to the content acceptance server S102. That is, for example, when a delay in a network that connects the node terminal N102 and the content acceptance server S102 is large, upload processing takes a long time. Accordingly, in such a case, the node terminal N102 uploads the content to a node terminal having a small delay with the content acceptance server S102, for example, to the node terminal N104, and the node terminal N104 uploads the same content from the node terminal N102 to the content acceptance server S102 instead of the node terminal N102. As a result of this, reduction in time to upload processing completion of the content can be achieved.

Here, a movement instruction of the upload content from the node terminal N102 to the node terminal N104 is performed by the traffic management device T101 that collects information of each of the node terminals N101, N102, N103, and 104.

A movement instruction of the upload content between the node terminals that is issued by the traffic management device T101 can be performed not only for the purpose of reducing a time required for upload processing of the content, but of securing redundancy of the uploaded content. For example, in a case where the uploaded content is temporarily stored in the node terminal N101, when a failure, such as a disk failure, occurs in the node terminal N101, access to the uploaded content may be lost.

Consequently, the traffic management device T101 can instruct the plurality of node terminals N101, N103, and N104 to hold upload content by instructing to copy the upload content to both of the other node terminals, for example, the node terminals N103 and N104. As a result of this, even in a case where a failure of a certain node terminal, for example, of the node terminal N101 occurs, it becomes possible to decrease a possibility that access to the upload content is lost.

In addition, when the same content exists in the plurality of node terminals, it is only necessary for the traffic management device T101 to execute to any one of the plurality of node terminals that hold the content calculation of a waiting time of the service system of the content acceptance server as an upload target of the content, for example, of the content acceptance server S101, and an upload instruction to the node terminal that holds the content. It is to be noted that even in the case where the same content is stored in the plurality of node terminals, the traffic management device T101 manages location information of the content, and that when guiding a user's access request, the traffic management device T101 provides information on the node terminal that serves as a guidance destination in consideration of vicinity of the user and the node terminal, a load state of the node terminal, etc.

In addition, in the above-mentioned explanation of the Example 1, a case where the traffic management device T101 calculates the waiting time of the service system of each of the content acceptance servers S101 and S102, and if the waiting time exceeds the previously set threshold value, the traffic management device T101 instructs each of the node terminals N101, N102, N103 and N104 to control the upload traffic amount so that the waiting time of the upload content is reduced below the threshold value has been explained.

However, the present invention is not limited to such case, and for example, when a state where the waiting time exceeds the threshold value has occurred for a long period in the service system of the specific content acceptance server, for example, of the content acceptance server S101, content to be uploaded to the service system of the target content acceptance server, for example, of the content acceptance server S101, is accumulated on the node terminals N101, N102, N103, and N104. Accordingly, when the state where the waiting time exceeds the threshold value has continued for a long period not less than a predetermined time limit, the traffic management device T101 measures the number of times that the waiting time exceeded the threshold value at a predetermined time interval for every service, and can regularly notifies the service system of the target content acceptance server, for example, of the content acceptance server S101 of a guide message that includes information on the measured number of times, and prompts that an acceptable traffic amount should be enhanced.

In addition, the traffic management device T101 can also perform calculation of charging to each of the content acceptance servers S101 and S102 according to an amount of the upload content stored on the node terminals N101, N102, N103, and N104.

### Example 2

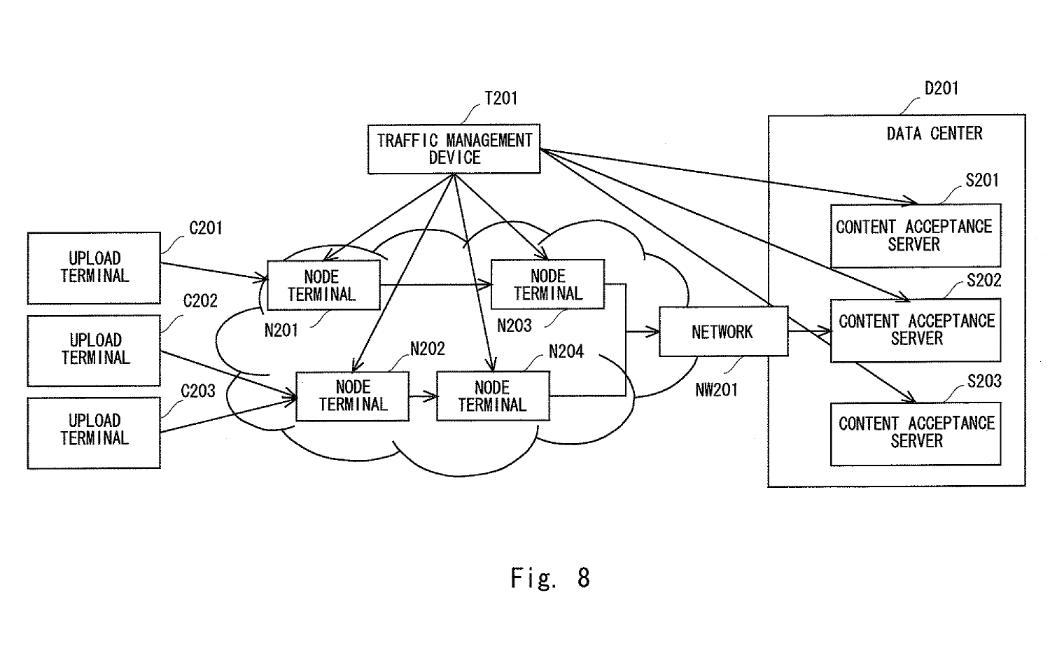

Next, specific operation will be explained using FIG. 8 as a specific example of the best mode for carrying out the traffic management system pertaining to the present invention. FIG. 8 is a network configuration diagram showing as the Example 2 an other example of a network configuration in the traffic management system pertaining to the present invention, and shows taking as an example a case where the traffic management device 300 shown in FIG. 5 as the third embodiment is applied as the traffic management device included in the traffic management system. It is to be noted that the traffic management device 300 shown in FIG. 5 is shown as a traffic management device T201 in FIG. 8.

The traffic management system shown in FIG. 8 includes: the traffic management device T201 including the traffic management device 300 shown in FIG. 5; three upload terminals C201, C202, and C203 that upload content; three content acceptance servers S201, S202, and S203 having service systems that accept content to be uploaded; and four node terminals N201, N202, N203, and N204 that are included in a node of a network. It is to be noted that the number of terminals and servers shown in FIG. 8 shows one example, and the arbitrary number of them may be used without limiting to the above number.

Here, unlike the case of FIG. 7, the three content acceptance servers S201, S202, and S203 of FIG. 8 operate as a data center D201, and a network NW201 of the data center D201 are shared and utilized by a plurality of service systems including the respective content acceptance servers S201, S202, and S203. In addition, the four node terminals N201, N202, N203, and N204 included in the network of FIG. 8 temporarily store upload content that is uploaded from the upload terminals C201, C202, and C203 to the service systems responding to services of the content acceptance servers S201, S202, and S203 based on control information from the traffic management device T201 until a waiting time of the upload content of the corresponding service system decreases a value not more than a threshold value set in advance, thereby enabling to perform control of upload traffic to the content acceptance servers S201, S202, and S203.

Since much of operation in the traffic management system of FIG. 8 of the Example 2 is the same as the operation in the traffic management system of FIG. 7 of the Example 1, hereinafter will be explained operation different from the operation in the traffic management system of FIG. 7 of the Example 1. Unlike the case of FIG. 7, the traffic management device T201 in the traffic management system of FIG. 8 further collects information on the network NW201 that is a common resource in addition to information of the content acceptance servers S201, S202, and S203.

Since the network NW201 is shared and utilized by the plurality of service systems of the data center D201, depending on a condition of the network NW201, greatly changes network quality that affects traffic amounts that can be accepted by the service systems of the content acceptance servers S201, S202, and S203 of the data center D201. Consequently, the traffic management device T201 collects information on a physical band, an available band, etc. as information on the network NW201, and calculates a traffic amount that can pass through the network NW201.

The traffic management device T201 compares a total value of traffic amounts (processing amounts in a queue) that can be accepted by the service systems of the content acceptance servers S201, S202, and S203 with a traffic amount (processing amount in the queue) that can pass through the network NW201, and if the traffic amount (processing amount in the queue) that can pass through the network NW201 is below the traffic amount (processing amount in the queue) that can be accepted by the service system of each of the content acceptance servers S201, S202, and S203, the traffic management device T201 corrects the traffic amount (processing amount in the queue) that can be accepted by the service system of each of the content acceptance servers S201, S202, and S203 to a traffic amount (processing amount in the queue) that can pass through the network NW201.

As a correction method of the traffic amount that can be accepted by the service system of each of the content acceptance servers S201, S202, and S203, considered are a method for fairly distributing and allocating the traffic amount that can pass through the network NW201 according to the number of content acceptance servers (three content acceptance servers S201, S202, and S203 in the case of FIG. 8) or the number of service systems on the content acceptance servers, a method for allocating the traffic amount that can pass through the network NW201 in a form proportional to a content amount for every service system of each of the content acceptance servers S201, S202, and S203 that has been currently accumulated on the node terminals N201, N202, N203, and N204, etc.

As explained in the above as the Examples 1 and 2, in the traffic management system pertaining to the present invention, a traffic management device controls a traffic amount to be uploaded according to a traffic amount that can be accepted by a service as a content acceptance destination in the service to which a user uploads content through a network, and thereby the service as the acceptance destination can accept a large amount of upload traffic at low cost.

Hereinbefore, configurations of the preferred embodiments of the present invention have been explained. However, note that such embodiments are mere exemplifications of the present invention, and do not limit the present invention at all. Those skilled in the art can easily understand that various modifications and changes can be made according to a particular application without departing from the gist of the present invention.

In addition, although the present invention has been explained as a hardware configuration in the above-mentioned embodiments, the present invention is not limited to this. In the present invention, arbitrary processing can also be achieved by making a CPU (Central Processing Unit) execute a computer program.

Further, the above-described program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

This application is based upon and claims the benefit of priority from Japanese patent application No. 2011-264711, filed on Dec. 2, 2011, the disclosure of which is incorporated herein in its entirety by reference.

### REFERENCE SIGNS LIST

100 TRAFFIC MANAGEMENT DEVICE
101 ARRIVAL RATE CALCULATION UNIT
102 PROCESSING AMOUNT CALCULATION UNIT
103 QUEUE MANAGEMENT UNIT
104 SCHEDULING CALCULATION UNIT
200 TRAFFIC MANAGEMENT DEVICE
201 ARRIVAL RATE CALCULATION UNIT
202 PROCESSING AMOUNT CALCULATION UNIT
203 QUEUE MANAGEMENT UNIT
204 SCHEDULING CALCULATION UNIT
205 CONTENT POSITION MANAGEMENT UNIT
300 TRAFFIC MANAGEMENT DEVICE
301 ARRIVAL RATE CALCULATION UNIT
302 PROCESSING AMOUNT CALCULATION UNIT
303 QUEUE MANAGEMENT UNIT
304 SCHEDULING CALCULATION UNIT
305 CONTENT POSITION MANAGEMENT UNIT
306 COMMON RESOURCE INFORMATION MANAGEMENT UNIT
C101 UPLOAD TERMINAL
C102 UPLOAD TERMINAL
C103 UPLOAD TERMINAL
N101 NODE TERMINAL
N102 NODE TERMINAL
N103 NODE TERMINAL
N104 NODE TERMINAL
S101 CONTENT ACCEPTANCE SERVER
S102 CONTENT ACCEPTANCE SERVER
T101 TRAFFIC MANAGEMENT DEVICE
C201 UPLOAD TERMINAL
C202 UPLOAD TERMINAL
C203 UPLOAD TERMINAL
D201 DATA CENTER
N201 NODE TERMINAL
N202 NODE TERMINAL
N203 NODE TERMINAL
N204 NODE TERMINAL
NW201 NETWORK
S201 CONTENT ACCEPTANCE SERVER
S202 CONTENT ACCEPTANCE SERVER
S203 CONTENT ACCEPTANCE SERVER
T201 TRAFFIC MANAGEMENT DEVICE

1. A traffic management device that manages traffic of upload content for every service, the traffic management device being configured to comprise at least:
arrival rate calculation unit for collecting information on the traffic of the upload content for every service, calculating a traffic amount of the upload content for every service to be uploaded, and converting it into an arrival rate in a queue;
processing amount calculation unit for collecting information on an upload traffic amount that can be processed by each service that accepts the upload content for every service, and converting it into a processing amount in the queue for every service;
queue management unit for calculating a waiting time of the upload content for every service to be uploaded based on the converted arrival rate of upload traffic of each service in the queue and the converted processing amount of the upload traffic; and
scheduling calculation unit for comparing the calculated waiting time for every service with a threshold value previously set for every service, and controlling a traffic amount of upload content that is made to flow in a corresponding service so that the waiting time of the upload content becomes not more than the threshold value for every corresponding service, if the waiting time exceeds the threshold value.

2. The traffic management device according to claim 1, wherein in the scheduling calculation unit, after the traffic amount of the upload content that is made to flow in the corresponding service is controlled so that the waiting time of the upload content becomes not more than the threshold value for every corresponding service, the queue management unit is made to sequentially recalculate the waiting time of the upload content that will be uploaded to the service at a predetermined time interval, and if it detects that the recalculated waiting time decreases not more than the threshold value, upload operation of the upload content of the service temporarily stored in a node of a network is restarted.

3. The traffic management device according to claim 1, wherein in the arrival rate calculation unit, information including at least a transmission destination of the upload content, a data size, and a communication band to the transmission destination is aggregated for every service that serves as the transmission destination, and the traffic amount of the upload content is calculated to convert into the arrival rate in the queue.

4. The traffic management device according to claim 1, wherein in the processing amount calculation unit, in the upload traffic amount that can be processed by the service that accepts the upload content being changed, information on the upload traffic amount that can be processed by the service is collected, and the processing amount in the queue is recalculated according to the changed upload traffic amount that can be processed by the service.

5. The traffic management device according to claim 1, wherein in the scheduling calculation unit, the number of times that the waiting time calculated by the queue management unit exceeded the previously set threshold value is measured for every service at a predetermined time interval, and notification of a guide message including information of the measured number of times is regularly performed to a service system that provides a corresponding service.

6. The traffic management device according to claim 1, configured to further comprise content position management unit for managing location information of the upload content temporarily stored in the node in the network by means of an instruction of the scheduling calculation unit, wherein in an access request to the upload content being issued from a user, the access request is guided to the node in the network in which the corresponding upload content has been stored.

7. The traffic management device according to claim 1, configured to further comprise common resource information management unit for monitoring a condition of a common resource and calculating a processing amount in a queue of the common resource when exists the common resource shared by a plurality of service systems that provide respective services, wherein in the queue management unit, the processing amount of each service that shares the common resource that is calculated in the processing amount calculation unit and the processing amount in the queue of the common resource calculated in the common resource information management unit are compared with each other, the processing amount having a smaller value is set as a processing amount in a queue of a corresponding service to use for calculation of a waiting time in a queue of upload content of the service in the queue management unit.

8. A traffic management system configured to comprise: one or more upload terminals that upload content through a network; one or more content acceptance servers having service systems that accept upload content through the network; one or more node terminals included in a node of the network; and a traffic management device that manages and controls traffic of the upload content uploaded from the upload terminal to the service system of the content acceptance server; wherein the traffic management device includes the traffic management device according to claim 1.

9. A traffic management method that manages traffic of upload content for every service, comprising at least:
collecting information on the traffic of the upload content for every service, calculating a traffic amount of the upload content for every service to be uploaded, and converting it into an arrival rate in a queue;
collecting information on an upload traffic amount that can be processed by each service that accepts the upload content for every service, and converting it into a processing amount in the queue for every service;
calculating a waiting time of the upload content for every service to be uploaded based on the converted arrival rate of upload traffic of each service in the queue, and the converted processing amount of the upload traffic; and
comparing the calculated waiting time for every service with a threshold value previously set for every service, and controlling a traffic amount of upload content that is made to flow in a corresponding service so that the waiting time of the upload content becomes not more than the threshold value for every corresponding service, if the waiting time exceeds the threshold value.

10. A non-transitory computer readable medium storing a computer executable traffic management program, wherein the traffic management method according to claim 9 is implemented as the computer executable traffic management program.

11. A traffic management device that manages traffic of upload content for every service, the traffic management device being configured to comprise at least:
arrival rate calculation means for collecting information on the traffic of the upload content for every service, calculating a traffic amount of the upload content for every service to be uploaded, and converting it into an arrival rate in a queue;
processing amount calculation means for collecting information on an upload traffic amount that can be processed by each service that accepts the upload content for every service, and converting it into a processing amount in the queue for every service;
queue management means for calculating a waiting time of the upload content for every service to be uploaded based on the converted arrival rate of upload traffic of each service in the queue and the converted processing amount of the upload traffic; and
scheduling calculation means for comparing the calculated waiting time for every service with a threshold value previously set for every service, and controlling a traffic amount of upload content that is made to flow in a corresponding service so that the waiting time of the upload content becomes not more than the threshold value for every corresponding service, if the waiting time exceeds the threshold value.
